(19) United States
(12) Patent Application Publication
(10) Pub. No.: US 2025/0251885 A1
(43) Pub. Date: Aug. 7, 2025

(54) CONTROL DEVICE, NON-TRANSITORY COMPUTER-READABLE STORAGE MEDIUM STORING PRINT MANAGEMENT PROGRAM, AND METHOD FOR PRODUCING PRINTED OBJECT

(71) Applicant: SEIKO EPSON CORPORATION, Tokyo (JP)

(72) Inventor: Yusuke YAMADA, SHIOJIRI-SHI (JP)

(21) Appl. No.: 19/047,160

(22) Filed: Feb. 6, 2025

(30) Foreign Application Priority Data
Feb. 7, 2024 (JP) 2024-016912

(51) Int. Cl. G06F 3/12; G06F 21/44; G06Q 30/04

(52) U.S. Cl. CPC G06F 3/1237; G06F 3/1204; G06F 21/44; G06Q 30/04

(57) ABSTRACT

A control device includes: a billing processing unit configured to execute billing processing for printing to a billing server; a storage unit storing destination information of a printing device acquired from a destination management server when at least one of an authentication of a user and an authentication of a computer is successful and an authentication of a print management program is successful; and a print processing unit configured to cause the printing device corresponding to the destination information to print print data, using the print management program, and the billing processing unit performs payment of a print fee, based on a result of printing.

The present application is based on, and claims priority from JP Application Serial Number 2024-016912, filed Feb. 7, 2024, the disclosure of which is hereby incorporated by reference herein in its entirety.

### BACKGROUND

### 1. Technical Field

The present disclosure relates to a control device, a non-transitory computer-readable storage medium storing a print management program, and a method for producing a printed object.

### 2. Related Art

According to the related art, a service for a user to pay a print fee and thus output a printed object with a printer at a place where the user is visiting is known. For example, a print service that enables the output of a printed object from a printer for a user who deposits money in advance to pay the cost of the output of the printed object and still has a deposit balance left, is known. JP-A-2023-125561 discloses a technique of determining whether a predetermined condition is satisfied when printing cannot be performed within a range of printable amount, and causing a printing mechanism to execute printing exceeding the range of printable amount and thus temporarily paying the cost in place of the user when the predetermined condition is satisfied.

JP-A-2023-125561 is an example of the related art.

Such a print service needs to prevent unauthorized use such as acquiring a printed object without paying the cost.

### SUMMARY

According to an aspect of the present disclosure, a control device includes: a billing processing unit configured to execute billing processing for printing to a billing server; a storage unit storing destination information of a printing device acquired from a destination management server when at least one of an authentication of a user and an authentication of a computer is successful and an authentication of a print management program is successful; and a print processing unit configured to cause the printing device corresponding to the destination information to print print data, using the print management program, and the billing processing unit performs payment of a print fee, based on a result of printing.

According to another aspect of the present disclosure, a non-transitory computer-readable storage medium storing a print management program is provided, the print management program causing a computer to function as: a billing processing unit configured to execute billing processing for printing to a billing server; a destination information acquisition unit configured to acquire destination information of a printing device from a destination management server when at least one of an authentication of a user and an authentication of the computer is successful and an authentication of the print management program is successful; and a print processing unit configured to cause the printing device to print print data, using the destination information, and the billing processing unit performs payment of a print fee, based on a result of printing.

According to still another aspect of the present disclosure, a method for producing a printed object includes: a first authentication step of authenticating a print management program for managing printing; a second authentication step of authenticating at least one of a user and a control device; a destination information acquisition step of acquiring destination information of a printing device from a destination management server when the authentication is successful in both the first authentication step and the second authentication step; a print processing step of causing the printing device corresponding to the destination information to print print data, using the print management program; and a billing processing step of collecting a cost, based on a result of printing.

### BRIEF DESCRIPTION OF THE DRAWINGS

FIG. 1 is a schematic view of a printing system.

FIG. 2 shows an example of a print log.

FIG. 3 shows an overall configuration of the printing system.

FIG. 4 shows a configuration of a portable device.

FIG. 5 schematically illustrates printed object production processing.

FIG. 6 is a sequence diagram showing the printed object production processing.

### DESCRIPTION OF EMBODIMENTS

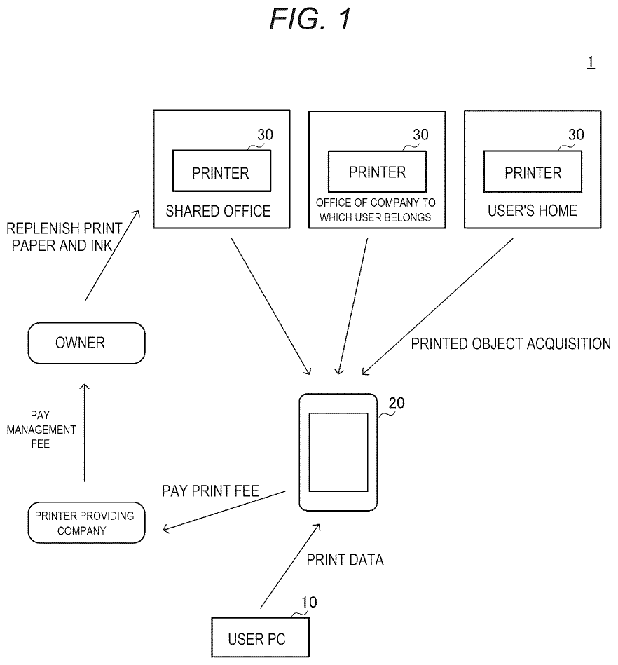

FIG. 1 is a schematic view of a printing system 1 according to an embodiment. In the printing system 1, a user transfers desired print data to be printed from a user PC 10 possessed by the user to a portable device 20. The user then designates a desired printer 30 from the portable device 20 and acquires a printed object with print data printed thereon from the printer 30.

The printer 30 is assumed to be a printer 30 installed in an office of a company to which the user belongs, a printer 30 installed in the user's home, and a printer 30 installed in a shared office. A shared printer 30 used by unspecified users, such as the printer 30 in the shared office, is available for use by paying a print fee. The user deposits money in advance and pays a print fee based on the acquisition of a printed object.

The print fee paid by the user is collected by the providing company providing the shared printer 30. A part of the collected print fee is paid as a management fee to the owner of the shared printer 30. The maintenance of the shared printer 30 such as the supply of print paper and ink is carried out by the owner.

Also, when using a plurality of printers 30 in this way, in some cases, the user may temporarily pay the print fee and requests the company to which the user belongs to pay back. In this case, in order to prove which printed object the user requests the print fee for, the user can cause the printer 30 to output a print log indicating the printed object that is the target of the request for the cost via the portable device 20.

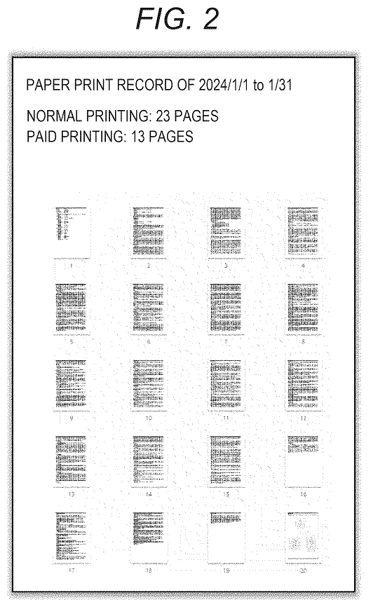

FIG. 2 shows an example of a print log. The print log shows a print period, the number of sheets in normal printing, and the number of sheets in paid printing. In this case, the paid printing is printing by the printer 30 executed in response to the user paying a print fee, such as the shared printer 30. The normal printing is printing that is not the paid printing. The normal printing is, for example, printing by the printer 30 at the user's home or the printer 30 at the company to which the user belongs. The print log shows the number of sheets printed in each of the paid printing and the normal printing.

Also, the print log includes a list of thumbnails of individual printed objects. Thus, a payment manager who manages the payment of costs to the user can check whether the printed object that is the target of the request for the cost is related to the business operation of the company to which the user belongs. The print log is outputted as a voucher in a predetermined format. The format is set, for example, by the company to which the user belongs. In this way, the print log shows the number of sheets of printed objects and the print contents. The print log may include at least one of the number of sheets of printed objects and the print contents.

The print contents, that is, the thumbnails of printed objects, may be displayed in such a way that the printed objects of the paid printing and the printed objects of the normal printing are identifiable from each other. For example, the printed objects of the paid printing and the printed objects of the normal printing may have different print areas from each other. In another example, an icon indicating one of the paid printing and the normal printing may be added to each thumbnail.

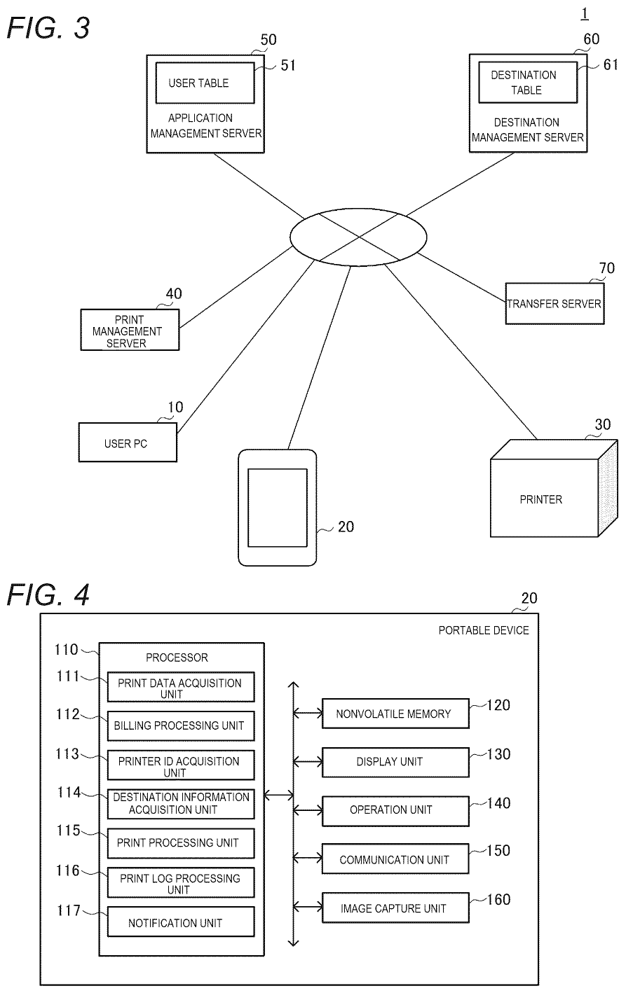

FIG. 3 shows an overall configuration of the printing system 1. The printing system 1 has the user PC 10, the portable device 20, the printer 30, a print management server 40, an application management server 50, a destination management server 60, and a transfer server 70. The user PC 10, the portable device 20, the printer 30, the print management server 40, the application management server 50, the destination management server 60, and the transfer server 70 are communicably connected to each other via a network.

The user PC 10 is an information processing device used by the user. The user PC 10 generates print data to cause the printer 30 to print a print target such as a character or an image designated by the user.

The portable device 20 is a portable information processing device used by the user. The portable device 20 may be, for example, a smartphone or a tablet terminal. The portable device 20 receives the print data from the user PC 10, transmits the print data to the printer 30 via the transfer server 70, and thus causes the printer 30 to print the print data.

The printer 30 is an example of a printing device. The printer 30 can perform monochrome printing or color printing, based on the print data generated by the user PC 10.

The print management server 40 manages the printing by the printer 30. The print management server 40 stores a printer table 41. In the printer table 41, a user ID that uniquely identifies at least one of the user and the portable device 20, and a printer ID of a printer which the user is permitted to use, correspond to each other. The user ID is, for example, information that identifies the user, and a user ID is allocated to each user. In another example, information that identifies the portable device 20 used by the user may be used as the user ID. Alternatively, the user ID may be information that identifies a combination of the user and the portable device 20. The printer which the user is permitted to use may be the printer at the company to which the user belongs, the shared printer, the printer at the user's home, and the like. The printer which the user is permitted to use can be suitably set and changed by a manager or the like. If one user uses a plurality of portable devices and printing is to be executed similarly no matter which one of the portable devices the user uses, a user ID that uniquely identifies the user may be employed. If a plurality of users use one portable device and printing is to be executed similarly no matter which one of the users uses the portable device, user IDs that uniquely identify the portable device may be employed.

The application management server 50 manages a print application (print app) for the portable device 20 to use a print service provided by the printing system 1. The print app is an example of a print management program. The application management server 50 also functions as a billing server that manages the billing for printing. The application management server 50 also functions as an authentication server that performs an authentication of the print app and the user. The application management server 50 is a server that performs the billing and authentication in an application store of the OS of the portable device 20. The print app is an example of the print management program to manage printing.

The application management server 50 stores a user table 51. In the user table 51, the user ID of a user who installs the print app, that is, a registered user, and the deposit balance of this user, correspond to each other. The application management server 50 also performs processing to pay a part of the amount of money collected as the print fee, as the management fee to the owner of the shared printer 30. That is, the application management server 50 functions as a distribution server.

The destination management server 60 notifies the portable device 20 of destination information that designates the printer 30. When notifying the portable device 20 of the destination information, the destination management server 60 checks whether the user of the portable device 20 and the print app installed in the portable device 20 are registered with the application management server 50.

The destination management server 60 stores a destination table 61. In the destination table 61, a printer ID that uniquely identifies the printer 30, and destination information designated as a destination used when transmitting print data to the printer 30, correspond to each other. The printer ID is, for example, information including randomly provided characters and symbols such as “4q3% v85 . . . ”, and the user cannot transmit the print data to the printer 30 unless the user acquires the destination information even if the user specifies the printer ID. The transfer server 70 acquires the print data and the destination information from the portable device 20 and transfers the print data to the printer 30.

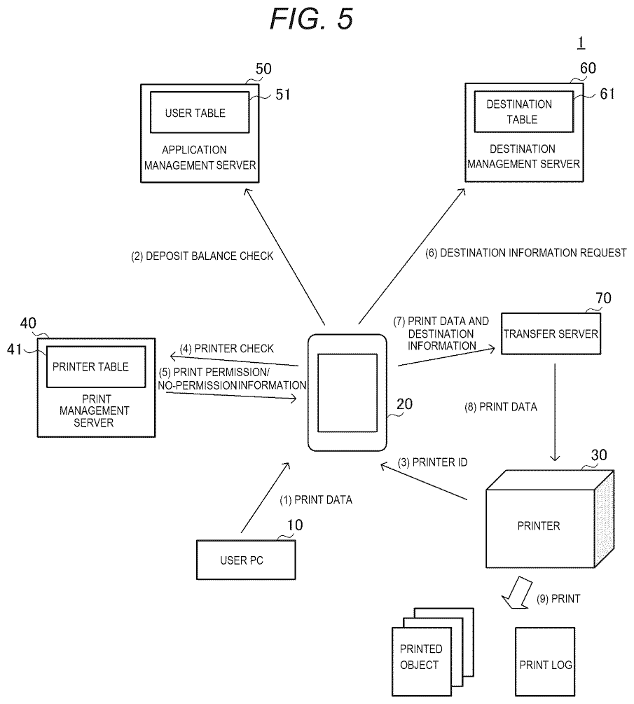

FIG. 4 shows the configuration of the portable device 20. The portable device 20 has a processor 110, a nonvolatile memory 120, a display unit 130, an operation unit 140, a communication unit 150, and an image capture unit 160. The processor 110 has a CPU, a ROM, and a RAM, and executes a program recorded in the ROM or the nonvolatile memory 120 and thus can control each part of the portable device 20. As such a program, the portable device 20 stores the foregoing print app. The processor 110 may be configured with a single chip or may be configured with a plurality of chips. Also, for example, an ASIC may be employed instead of the CPU, or a configuration in which the CPU and the ASIC cooperate with each other may be employed. In the nonvolatile memory 120, the program executed by the processor 110 and data or the like are recorded.

The display unit 130 displays various information. The operation unit 140 accepts a user's operation. The operation unit 140 may be provided as unified with the display unit 130 in the form of a touch panel. The communication unit 150 is one or a plurality of antennas to perform wireless communication with an external device. The communication unit 150 may be a cable connector to perform wired communication with an external device. The antenna and the cable connector are also referred to as communication interfaces. The image capture unit 160 captures an image.

The portable device 20 in the present embodiment can acquire the print data from the user PC 10 and can transfer the print data to the printer 30, as described above. As a functional configuration for this purpose, the processor 110 has a print data acquisition unit 111, a billing processing unit 112, a printer ID acquisition unit 113, a destination information acquisition unit 114, a print processing unit 115, a print log processing unit 116, and a notification unit 117.

The functions of the print data acquisition unit 111, the billing processing unit 112, the printer ID acquisition unit 113, the destination information acquisition unit 114, the print processing unit 115, the print log processing unit 116, and the notification unit 117 are implemented by the processor 110 reading out and executing the program stored in the nonvolatile memory 120. That is, in the description below, the processing described as being executed by the print data acquisition unit 111, the billing processing unit 112, the printer ID acquisition unit 113, the destination information acquisition unit 114, the print processing unit 115, the print log processing unit 116, and the notification unit 117 is the processing executed by the processor 110.

The print data acquisition unit 111 acquires the print data from the user PC 10 via the communication unit 150. The billing processing unit 112 performs billing processing, which is processing related to the billing, in cooperation with the application management server 50. The billing processing includes processing to deposit money at the application management server 50 in response to a payment of money, that is, processing to increase the deposit amount, and processing to reduce the deposit amount at the application management server 50 in response to the collection of the print fee.

The printer ID acquisition unit 113 acquires the printer ID from the printer 30. In the present embodiment, the casing of the shared printer 30 is provided with a two-dimensional code representing the printer ID of the printer 30. The user uses the image capture unit 160 of the portable device 20 to capture an image of this two-dimensional code. The printer ID acquisition unit 113 acquires the printer ID, based on this captured image. The printer ID acquisition unit 113 is an example of an identification information acquisition unit that acquires dentification information of a printer.

The destination information acquisition unit 114 acquires the destination information corresponding to the printer ID from the destination management server 60. The print processing unit 115 performs processing related to the printing of the print data by the printer 30. The print log processing unit 116 performs processing to output the print log as shown in FIG. 2. The print log processing unit 116 acquires an attribute of the printer 30 outputting a printed object, from the print management server 40. The attribute indicates one of the paid printing, which requires the payment of the print fee by the user in the printing, and the normal printing, which is not the paid printing. The print log processing unit 116 generates and outputs a print log with reference to the attribute. The notification unit 117 notifies the user of an error when the printing of the print data cannot be performed. Detailed processing by each unit will be described later. The attribute may be any information indicating the printer 30 and may be, for example, information such as the company to which the user belongs, the user's home, or the shared printer.

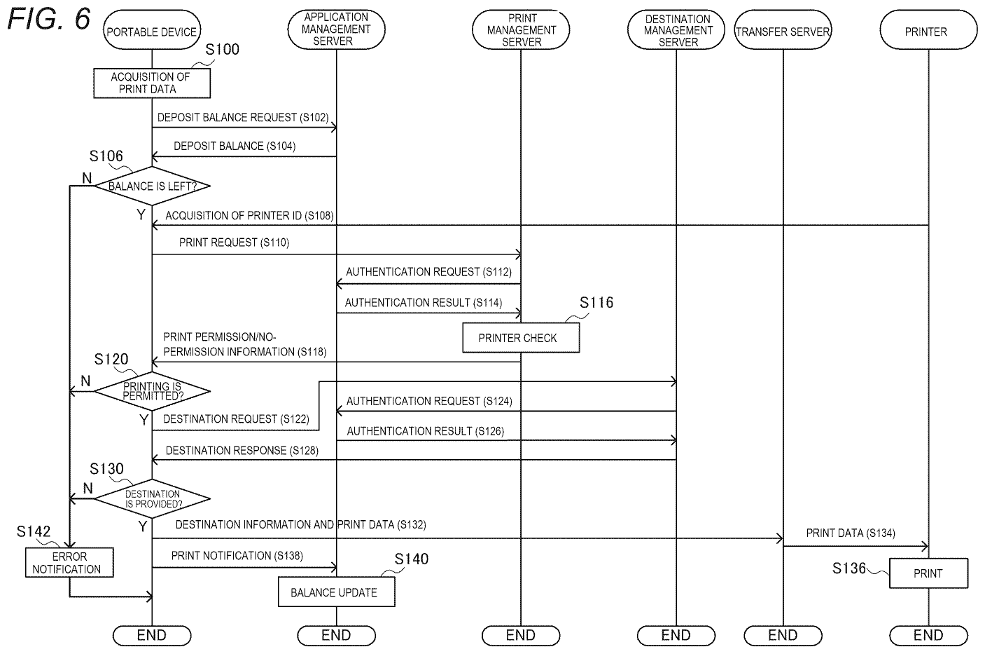

An outline of printed object production processing for the user to acquire a printed object with the printer 30 will now be described with reference to FIG. 5. When the user wants to print a printed object using the printer 30 that requires the payment of the print fee, the user first transmits print data from the user PC 10 to the portable device 20 (1). Next, the portable device 20 checks the deposit balance of the user with the application management server 50 (2).

The portable device 20 acquires the printer ID identifying the printer 30 which the user wants to use, when the deposit balance is higher than the print fee (3). Next, the portable device 20 designates the printer ID and checks, with the print management server 40, whether the printer 30 which the user wants to use is a printer which the user is permitted to use (4).

The print management server 40 refers to the printer table 41 and checks whether the printer ID corresponds to the user ID of the user. The print management server 40 also requests an authentication about whether the print app of the portable device 20 and the user are registered with the application management server 50. When the use of the printer 30 which the user wants to use is permitted and the authentication of the print app and the user is successful, the print management server 40 transmits print permission/no-permission information indicating that the printing is permitted, to the portable device 20. When the use of the printer 30 which the user wants to use is not permitted or when the authentication of at least one of the print app and the user is not successful, the print management server 40 transmits print permission/no-permission information indicating that the printing is not permitted, to the portable device 20 (5).

When the portable device 20 receives the print permission/no-permission information indicating that the printing is permitted, the portable device 20 requests the destination management server 60 to provide destination information (6). The destination management server 60 requests the application management server 50 to perform an authentication of the print app of the portable device 20 and the user. When the authentication is successful, the destination management server 60 refers to the destination table 61 and transmits the destination information corresponding to the printer ID to the portable device 20.

Next, the portable device 20 transmits the destination information and the print data to the transfer server 70 (7). The transfer server 70 transmits the print data to the printer 30 indicated by the destination information (8). The printer 30 then prints the print data and thus acquires a printed object (9).

Also, the print data corresponding to the printed object or a thumbnail of the print data is stored in the portable device 20. The portable device 20 outputs a print log to an external device in response to an operation by the user. When this external device is the printer 30, the printer 30 prints and outputs the print log.

FIG. 6 is a sequence chart showing printed object production processing. Each process in the printed object production processing will be described with reference to FIG. 6. First, the print data acquisition unit 111 of the portable device 20 receives print data from the user PC 10 (step S100). Next, the billing processing unit 112 of the portable device 20 transmits a deposit balance request to the application management server 50 (step S102). The deposit balance request includes the user ID. The application management server 50 refers to the user table 51, specifies the deposit balance corresponding to the user ID indicated in the deposit balance request, and sends back the deposit balance to the portable device 20 (step S104).

Upon receiving the billing balance, the billing processing unit 112 of the portable device 20 compares the billing balance with the print fee. In the portable device 20, for example, amount-of-money data representing an amount of money corresponding to the print settings of the printer 30 such as color printing or monochrome printing is stored in advance in a storage unit such as the nonvolatile memory 120. The billing processing unit 112 of the portable device 20 calculates the print fee required for printing the print data, based on the amount-of-money data.

When the deposit balance is lower than the print fee, the billing processing unit 112 of the portable device 20 determines that the deposit balance is not left (N in step S106). In this case, the notification unit 117 of the portable device 20 outputs an error notification (step S142) and ends the processing. The error notification is information that notifies the user that the printing cannot be performed. The error notification is displayed as text information, for example, at the display unit 130. In another example, information to the effect that the printing cannot be performed may be outputted as a voice, using a speaker provided in the portable device 20 or a speaker separate from the portable device 20.

When the deposit balance is higher than the print fee, the billing processing unit 112 of the portable device 20 determines that the deposit balance is left (Y in step S106). In this case, the printer ID acquisition unit 113 of the portable device 20 acquires the printer ID and temporarily stores the printer ID in the RAM (step S108). Specifically, the printer ID acquisition unit 113 displays a guidance such as “Read the two-dimensional code of the printer” at the display unit 130. When an image of the two-dimensional code is captured by the image capture unit 160 in response to the user's operation, the printer ID acquisition unit 113 analyzes the captured image and thus acquires the printer ID. In this way, the printer ID acquisition unit 113 acquires the printer ID captured by the image capture unit 160.

In another example, the portable device 20 and the printer 30 may be configured, for example, to be able to perform short-range direct wireless communication without using any relay device, such as Bluetooth (trademark registered) or Wi-Fi Direct. In this case, the printer 30 stores the printer ID, and the printer ID acquisition unit 113 of the portable device 20 may acquire the printer ID from the printer 30 via direct wireless communication.

In any case, when the user located at a place facing the printer 30 wants to have a printed object output from the printer 30 situated in front of the user, the printer ID acquisition unit 113 acquires the printer ID of this printer 30.

Next, the print processing unit 115 of the portable device 20 transmits a print request to the print management server 40 (step S110). The print request includes the printer ID, the user ID, and a token indicating that the print app is already authenticated. The user ID and the token are issued by the application management server 50. The user ID and the token are an example of authentication information to authenticate the user and the print app.

Upon acquiring the print request, the print management server 40 transmits an authentication request to the application management server 50 (step S112). The authentication request is information that requests an authentication about whether the print app and the user are registered with the application management server 50. The authentication request includes the user ID and the token included in the print request.

Upon receiving the authentication request, the application management server 50 checks that the token is issued by the application management server 50 and that the user ID is registered in the user table 51. When these are checked, the application management server 50 determines that the authentication is successful. When the check about at least one of the print app and the user cannot be carried out, the application management server 50 determines that the authentication is failed. The application management server 50 transmits an authentication result indicating that the authentication is successful or that the authentication is failed, to the print management server 40 (step S114).

Next, the print management server 40 refers to the printer table 41 and checks whether the use by the user, of the printer 30 identified by the printer ID, that is, the printer 30 which the user wants to use, is permitted (step S116). Specifically, the print management server 40 refers to the printer table 41, and determines that the use of the printer 30 which the user wants to use is permitted, when the user ID included in the print request and the printer ID correspond to each other.

The order of processing of the authentication request transmission processing (step S112) and the printer checking processing (step S116) is not limited to the order described in the embodiment. The authentication request transmission processing (step S112) and the printer checking processing (step S116) may be executed in parallel, or the printer checking processing (step S116) may be executed before the authentication request transmission processing (step S112).

When the print management server 40 acquires the authentication result indicating that the authentication is successful from the application management server 50 and the use of the printer 30 which the user wants to use is permitted, the print management server 40 determines that the printing is permitted. When the print management server 40 does not acquire the authentication result indicating that the authentication is successful from the application management server 50 or when the use of the printer 30 which the user wants to use is not permitted, the print management server 40 determines that the printing is not permitted. The print management server 40 then transmits print permission/no-permission information indicating that the printing is permitted or that the printing is not permitted, to the portable device 20 (step S118).

Upon receiving the print permission/no-permission information, the print processing unit 115 of the portable device 20 temporarily stores the print permission/no-permission information in a storage unit such as the RAM. When the print permission/no-permission information indicates that the printing is not permitted (N in step S120), the notification unit 117 gives the user an error notification to the effect that the printing cannot be performed (step S142) and ends the processing.

Meanwhile, when the print permission/no-permission information indicates that the printing is permitted (Y in step S120), the destination information acquisition unit 114 transmits a destination request to the destination management server 60 (step S122). The destination request includes the printer ID, the user ID, and the token. When the authentication of the print app and the user is successful, the destination management server 60 sends back destination information. Therefore, the destination management server 60 first transmits an authentication request to the application management server 50 (step S124). The authentication request includes the user ID and the token.

Upon receiving the authentication request, the application management server 50 checks that the token is issued by the application management server 50 and that the user ID is registered in the user table 51. The application management server 50 then transmits an authentication result indicating that the authentication is successful or that the authentication is failed, to the destination management server 60 (step S126). This processing is similar to the processing of step S114.

Upon receiving the authentication result, the destination management server 60 transmits a destination response to the portable device 20 (step S128). Specifically, when the destination management server 60 receives the authentication result indicating that the authentication is successful, the destination management server 60 refers to the destination table 61, specifies the destination information corresponding to the printer ID indicated in the destination request, and transmits a destination response including the destination information to the portable device 20. Meanwhile, when the destination management server 60 receives the authentication result indicating that the authentication is failed, the destination management server 60 transmits a destination response indicating that the authentication is failed, without including the destination information, to the portable device 20. In this way, the destination information is transmitted from the destination management server when the destination management server 60 receives the authentication result indicating that the authentication of the print app and the user is successful.

Upon receiving the destination response, the destination information acquisition unit 114 of the portable device 20 checks whether the destination information is acquired. When the destination information is not included in the destination response (N in step S130), the destination information acquisition unit 114 advances the processing to step S142. In this case, the notification unit 117 of the portable device 20 gives an error notification (step S142) and ends the processing.

When the destination information is included in the destination response (Y in step S130), the destination information acquisition unit 114 of the portable device 20 acquires the destination information and temporarily stores the destination information in a storage unit such as the RAM. The print processing unit 115 of the portable device 20 then causes print data to be transmitted to the destination indicated by the destination information (step S132). Specifically, the print processing unit 115 transmits the destination information and the print data to the transfer server 70. After transmitting the destination information and the print data, the print processing unit 115 deletes the printer ID and the destination information stored in the RAM or the like.

Subsequently, the transfer server 70 transmits the print data to the destination indicated by the destination information (step S134). The printer 30 which the user wants to use receives the print data, performs printing based on the print data, and thus provides a printed object (step S136).

The billing processing unit 112 of the portable device 20, after transmitting the print data in step S132, transmits a print notification indicating that the printing is performed, to the application management server 50 (step S138). The print notification indicates the print fee for the printing by the printer 30. The print fee is calculated by the billing processing unit 112, based on the amount-of-money data representing the correspondence between the print settings such as color or monochrome printing and the amount of money. Upon receiving the print notification, the application management server 50 subtracts the print fee from the deposit balance corresponding to the user ID of the user and thus updates the deposit balance (step S140). The processing by the billing processing unit 112 is an example of billing processing in which the print fee is paid, based on the print result.

The entity that transmits the print fee to the application management server 50 is not limited to the portable device 20. For example, the printer 30 may transmit the print fee to the application management server 50. In this case, the printer 30 receives the print data along with the user ID. When performing the printing, the printer 30 transmits the user ID and the print fee to the application management server 50. In this case, the print fees per sheet for color printing and monochrome printing are set in advance in the printer 30, and the printer 30 calculates the print fee corresponding to the printed object.

As described above, in the printing system 1 according to the present embodiment, when the print app and the user are authenticated, the portable device 20 is notified of the destination information of the printer 30. Therefore, unauthorized use of the printing system 1 such as acquiring a printed object without paying the print fee can be prevented. Also, when the print permission/no-permission information indicates that the printing is permitted, the printer 30 which the user wants to use can be made to print the print data. Thus, the printer available to the user can be limited. Also, on completion of the printed object production processing, the portable device 20 deletes the destination information from the storage unit. Thus, the information of the printer 30 can be prevented from being leaked to a third party.

When the deposit balance is lower than the print fee, that is, when the deposit balance corresponding to the printing is not left, the processing from step S108 onward is not performed. That is, in this case, the destination information acquisition unit 114 prohibits the transmission of the authentication information including the user ID and the token to the destination management server 60. In this case, the transmission of the print data by the print processing unit 115 to the printer 30 via the transfer server 70 is prohibited as well. Thus, printing in the state where the deposit is not left can be prevented.

Also, since only the destination management server 60 knows the destination information of the printer 30, the authentication of both the user and the print app must be successful in order to acquire the destination information from the destination management server 60. Therefore, an output of a printed object based on the use of the print app by a user using an unauthorized print app or by a user who is not registered with the application management server 50 can be prevented. Also, since a printed object is not output when it is not confirmed that a deposit balance higher than the print fee is left, printing without paying the print fee can be prevented.

As described above, in the printing system 1 according to the present embodiment, when the print app and the user are authenticated, the portable device 20 is notified of the destination information of the printer 30. Thus, unauthorized use of the printing system 1 such as acquiring a printed object without paying the cost can be prevented.

The foregoing embodiment is described by way of example to carry out the present disclosure, and various other embodiments can be employed.

In a first modification example, the balance of the user may be checked via the destination management server 60. Specifically, the billing processing unit 112 may request the destination management server 60 to inquire about the deposit balance of the user from the application management server 50. In this case, upon receiving the destination request, the destination management server 60 requests the application management server 50 to perform not only the authentication of the print app and the user but also the check of the balance of the user. The destination management server 60 then acquires the deposit balance of the user from the application management server 50 and transmits the deposit balance to the portable device 20.

In a second modification example, the print log processing unit 116 may separately generate and output print logs of the paid printing and the normal printing. Thus, the payment manager can check only necessary information for payment.

In a third modification example, an attribute indicating that no log is needed may be allocated to some printers by the print management server 40. In this case, the print log processing unit 116 may be configured not to output a print log for the printer with the attribute indicating that no log is needed. Thus, the volume of data stored in the nonvolatile memory 120 can be prevented from being excessively large. For example, it is conceivable that the attribute indicating that no log is needed is allocated to a printer that performs the normal printing.

In a fourth modification example, the print data may be transmitted along with the printer ID to the print management server 40 and may be transmitted from the print management server 40 to the printer 30 via the transfer server 70. In this case, the print management server 40 can receive the print data along with the user ID from the portable device 20 and can store the print data in the nonvolatile memory 120 as a print log corresponding to the user ID.

In a fifth modification example, the print log processing unit 116 may transmit the generated print log to the application management server 50 functioning as a distribution server. Thus, the owner can check the printed object that is the target of billing.

In a sixth modification example, the print data may be transmitted from the portable device 20 directly to the printer 30 without using the transfer server 70.

In a seventh modification example, the print management server 40, the application management server 50, the destination management server 60, and the transfer server 70 may be provided as a unified body, and the functions of one of these servers may be provided in another server. In this way, the functions of these servers may be implemented by one of the servers provided in the printing system 1, and the functions of each server are not limited to those of the embodiment.

In an eighth modification example, the communication unit may communicate with the user PC, the print management server, the application management server, the destination management server, and the transfer server, using different communication interfaces from each other and in conformity with different communication protocols from each other. Alternatively, the communication unit may communicate with a part or all of these servers, using the same communication interface and in conformity with the same communication protocol.

The foregoing embodiments are described by way of example to carry out the present disclosure, and various other embodiments can be employed. Various modifications and changes can be made without departing from the spirit and scope of the present disclosure described in the claims, for example, applying a modification example of one embodiment to another embodiment, or the like.

The present disclosure can also be applied as a program executed by a computer or as a method. Also, the present disclosure may be implemented as a single device as described above or may be implemented using components of a plurality of devices, and may include various aspects. Also, suitable changes can be made, such as a part being software and a part being hardware. Moreover, the present disclosure can be applied as a recording medium of a program that controls the system. Of course, the recording medium of the program may be a magnetic recording medium or a semiconductor memory, and any recording medium to be developed in the future can be similarly considered. The present disclosure may also be applied as a printer driver or an application that executes a part or all of the processing in the foregoing flowchart.

What is claimed is:

1. A control device comprising:
a billing processing unit configured to execute billing processing for printing to a billing server;
a storage unit storing destination information of a printing device acquired from a destination management server when at least one of an authentication of a user and an authentication of a computer is successful and an authentication of a print management program is successful; and
a print processing unit configured to cause the printing device corresponding to the destination information to print print data, using the print management program,
wherein the billing processing unit performs payment of a print fee, based on a result of printing.

2. The control device according to claim 1, further comprising:
a communication unit configured to acquire authentication information to perform the authentication, from an authentication server, and transmit the authentication information to the destination management information, wherein
the destination information is transmitted from the destination management server when the destination management server receives an authentication result indicating that the authentication of the print management program and the user is successful.

3. The control device according to claim 2, wherein
the communication unit prohibits the transmission of the authentication information to the destination management server when a deposit balance corresponding to the printing is not left.

4. The control device according to claim 3, wherein
the billing processing unit transmits identification information of the user to the destination management server and thus causes the destination management server to inquire about the deposit balance from the billing server.

5. The control device according to claim 1, further comprising:
an identification information acquisition unit configured to acquire identification information of the printing device; and
a destination information acquisition unit configured to acquire the destination information of the printing device corresponding to the identification information of the printing device, wherein
the print processing unit causes the print data to be transmitted to a destination indicated by the destination information.

6. The control device according to claim 1, further comprising:
an identification information acquisition unit configured to acquire identification information of the printing device, wherein
the print processing unit
transmits the identification information of the printing device and the print data to a print management server, and
transmits the print data to the printing device via the print management server.

7. The control device according to claim 1, further comprising:
an identification information acquisition unit configured to acquire identification information of the printing device, wherein
amount-of-money data representing a correspondence between a print setting based on the identification information, and an amount of money, is stored in a storage unit, and
the billing processing unit performs payment of the print fee, based on the amount-of-money data.

8. The control device according to claim 1, wherein
the billing server is a server that performs billing at an application store of an OS.

9. The control device according to claim 1, wherein
the billing processing includes processing to reduce a deposit amount in response to collection of a cost and processing to increase the deposit amount in response to payment of money.

10. The control device according to claim 1, wherein
the print processing unit prohibits the transmission of the print data to the printing device when a deposit balance corresponding to the printing is not left.

11. The control device according to claim 1, functioning as a print log processing unit configured to transmit a print log corresponding to printing by the printing device, to distribution server that pays a part of the print fee to an owner of the printing device.

12. A non-transitory computer-readable storage medium storing a print management program, the print management program causing a computer to function as:
a billing processing unit configured to execute billing processing for printing to a billing server;
a destination information acquisition unit configured to acquire destination information of a printing device from a destination management server when at least one of an authentication of a user and an authentication of the computer is successful and an authentication of the print management program is successful; and
a print processing unit configured to cause the printing device to print print data, using the destination information,
wherein the billing processing unit performs payment of a print fee, based on a result of printing.

13. A method for producing a printed object, the method comprising:
a first authentication step of authenticating a print management program for managing printing;
a second authentication step of authenticating at least one of a user and a control device;
a destination information acquisition step of acquiring destination information of a printing device from a destination management server when the authentication is successful in both the first authentication step and the second authentication step;
a print processing step of causing the printing device corresponding to the destination information to print print data, using the print management program; and
a billing processing step of collecting a cost, based on a result of printing.
